(19) United States
(12) Patent Application Publication
(10) Pub. No.: US 2025/0362942 A1
(43) Pub. Date: Nov. 27, 2025

(54) AUTOMATED CONTENT GENERATION FOR INSTRUCTIONAL INFORMATION VIA GENERATIVE AI INTEGRATION

(71) Applicant: Microsoft Technology Licensing, LLC, Redmond, WA (US)

(72) Inventors: Vipul GARG, Kirkland, WA (US); Javier Ricardo ESCOBAR AVILA, Redmond, WA (US)

(21) Appl. No.: 18/671,426

(22) Filed: May 22, 2024

(51) Int. Cl. G06F 9/451; G06F 40/20

(52) U.S. Cl. CPC G06F 9/453

(57) ABSTRACT

Systems, methods, and software are disclosed herein for automated content generation for instructional information via generative AI integration in various implementations. In an implementation, a computing apparatus identifies a sequence of steps to accomplish a task in an application. The computing apparatus generates a script for a browser automation tool to perform an interaction with an instance of the application based on the sequence of steps. The computing apparatus causes the browser automation tool to execute the script, and the computing apparatus captures a video of the interaction with an instance of the application based on the script. The computing apparatus causes display of the video in a user interface of the application.

### TECHNICAL FIELD

Aspects of the disclosure are related to the field of automated content generation, including video generation, and to the use of browser automation tools for automated interaction with software applications.

### BACKGROUND

Software applications, particularly productivity applications, which have wide-ranging functionality allow users to accomplish many different tasks for many different uses. Such breadth as well as depth of functionality enables users to develop a variety of content and to customize their content in a number of ways. For example, to generate a data chart for spreadsheet data, the user can generate a number of different types of charts, each of which summarizes the data in a particular way and which can be customized in a number of ways.

However, wide-ranging functionality of software applications gives rise to complex user interfaces and, in some cases, an unintuitive organization of the functionality which can be challenging for a user to navigate. To address this, software applications typically provide help content in the form of written instructions directed to teaching the user how to use the application or more specifically to accomplishing certain tasks, particularly those tasks which would be of interest to many users. When the user has a particular task in mind, he/she may search the help content for a relevant article or look to external sources of information, such as user forums or FAQs. However, the search for relevant content can be hit-or-miss particularly if the user lacks the vocabulary or jargon which is associated with the application or its features. For example, a user may want to add a particular shadow effect to the title of a document but does not know that the desired effect is called “drop shadow.” The user may eventually hone in on the answer but at the cost of lost time and productivity.

Moreover, even when the help content is on point, the attention span of many users may not be conducive to consuming anything but the most terse presentation of material. Given the prevalence of highly concentrated multimedia communication (e.g., thirty-second videos) in modern culture, users may prefer and indeed may be more successful with information presented in forms other than text. However, this too presents challenges with respect to producing and maintaining a library of multimedia content that addresses the most common questions of users, which is applicable to any of multiple different platforms, and that is fresh, i.e., relevant to the latest versions of the application. A user may eventually become proficient in using the application but remain unable to fully exploit many of the advantages that would otherwise be beneficial to the user.

### OVERVIEW

Technology is disclosed herein for automated content generation for instructional information via generative AI integration in various implementations. In an implementation, a computing apparatus identifies a sequence of steps to accomplish a task in an application. The computing apparatus generates a script for a browser automation tool to perform an interaction with an instance of the application based on the sequence of steps. The computing apparatus causes the browser automation tool to execute the script, and the computing apparatus captures a video of the interaction with an instance of the application based on the script. The computing apparatus causes display of the video in a user interface of the application.

In an implementation, to generate the script for the browser automation tool, the computing apparatus prompts a generative AI model to generate a list of graphical user interface (GUI) elements based on the sequence of steps. The computing apparatus then generates the script based on the list of GUI elements. In some implementations, the script is generated by a generative AI model, such as a large language model, based on the sequence of steps.

This Overview is provided to introduce a selection of concepts in a simplified form that are further described below in the Detailed Description. It may be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure may be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates an operational environment for automated content generation via generative AI integration in an implementation.

FIG. 2 illustrates a process for automated content generation via generative AI integration in an implementation.

FIG. 3 illustrates an operational environment for automated content generation via generative AI integration in an implementation.

FIG. 4 illustrates a workflow for automated content generation via generative AI integration in an implementation.

FIG. 5 illustrates a workflow for automated content generation via generative AI integration in an implementation.

FIG. 6 illustrates a workflow for automated content generation via generative AI integration in an implementation.

FIGS. 7A-7G illustrate a user experience of an application for a process of automated content generation via generative AI integration in an implementation.

FIG. 8 illustrates a computing system suitable for implementing the various operational environments, architectures, processes, scenarios, and sequences discussed below with respect to the other Figures.

### DETAILED DESCRIPTION

Various implementations are disclosed herein for automated content generation of instructional information relating to the use of software applications. As disclosed herein, the technology allows for automated creation of content such as videos and screenshots which simulate a user interaction for accomplishing a task in a software application. In various scenarios, a user who is working in an application, such as spreadsheet or word processing application, requests information (e.g., instructions) for how to accomplish a task in the application. The application service or system identifies instructions (e.g., a sequence of steps that the user is to perform) to accomplish the task and generates a script to be executed by a browser automation tool to execute the steps in an instance of the application. As the browser automation tool executes the steps in the instance of the application in a browser window, the interaction is captured as video, screenshots, or other media which can then be displayed to the user in response to the request. Subsequent to the capturing the video and/or screenshots, the system may store the recorded content for display for other users of the application who make the same request.

In various implementations, to generate the script, the application service sends the instructions to a generative artificial intelligence (AI) model, such as large language model (LLM), which generates a list of the graphical user interface (GUI) elements described or implicated in the instructions. The generative AI model may be a general-purpose model (e.g., GPT-4) or a fine-tuned generative AI model which has been trained to generate lists of GUI elements based on sequences of steps in the instructions for the application or a suite of applications. Fine-tuning a generative AI model includes adjusting the parameters of a pretrained model according to a specific dataset to adapt the model's output to a particular task. The generative AI model may be tasked with identifying the best or most appropriate GUI elements (e.g., buttons, menu options) to accomplish the steps in the instructions. The generation AI model returns the list of GUI elements to the application service which then generates the script for the browser automation tool based on the list.

In some implementations, to generate the script for the browser automation tool, the application service may execute a functionality for script generation, such as a service which populates a script template based on the list of GUI elements. In some cases, the application service may again be a general-purpose or fine-tuned generative AI model. For example, the generative AI model may be specially trained or fine-tuned to generate source code for executing the GUI elements according to the sequence of steps, with the source code drafted in a programming language of the browser automation tool. In addition to the source code based on sequence of steps, the source code may include code for the automation tool to set up an instance of the application and add sample content for demonstrating the instructions.

With an automation script generated, the application service causes a browser automation tool (e.g., Selenium) to execute the script. To execute the script, in various implementations, the browser automation tool opens an instance of the application in a browser window and populates a document, file, or other content container with sample content. The browser automation tool then performs the sequence of steps according to the script. As the browser automation tool performs the steps, the prescribed interaction with the application in the browser window is recorded. In various implementations, the interaction is captured as video but may also or alternatively be captured as images (e.g., screenshots) as each step is executed. As the tool progresses through the interaction, the GUI elements identified in the list of GUI elements may be visually highlighted for the convenience of the viewer.

The application service may process the recorded content (e.g., video, screencaptures) prior to surfacing the content to the user in the user interface. Such processing may include editing the video to remove periods of inactivity, adding captions based on the sequence of steps, and compressing the recorded content for transmission. Subsequent to processing, the application service causes the recorded content to be displayed in the user interface where the user entered his/her request, such as a chat pane of an application assistant functionality or as viewer pane overlaying the user interface. The application service may also store the recorded content for responding to similar requests from other users.

In some scenarios, upon identifying a sequence of steps for accomplishing a task in an application, the application service may task a generative AI model with generating an automation script based on the sequence of steps directly (e.g., without the generation of a list of GUI elements). In some scenarios, to identify the sequence of steps, the application service may search existing content (e.g., documentation, user manuals) for instructions, or the application service may prompt a generative AI model to generate the sequence of steps on which the automation script will be based.

Generative AI models of the technology disclosed herein include large-scale foundation models trained on massive quantities of diverse, unlabeled data using self-supervised, semi-supervised, or unsupervised learning techniques. Such models may be based on a number of different architectures, such as generative adversarial networks (GANs), variational auto-encoders (VAEs), and transformer models, including multimodal transformer models. Foundation models capture general knowledge, semantic representations, and patterns and regularities in or from the data, making them capable of performing a wide range of downstream tasks. In some scenarios, a foundation model may be fine-tuned for specific downstream tasks. Foundation models include BERT (Bidirectional Encoder Representations from Transformers) and ResNet (Residual Neural Network). Fine-tuning a foundation model involves adjusting the parameters of the pretrained model according to a specific dataset to adapt the model's output to a particular task. Types of foundation models may be broadly classified as or include pre-trained models, base models, and knowledge models, depending on the particular characteristics or usage of the model. Foundation models may be multimodal or unimodal depending on the modality of the inputs.

Large language models (LLMs) are a type of generative AI which processes and generates natural language text. These models are trained on massive amounts of text data and learn to generate coherent and contextually relevant responses given a prompt or input text. LLMs are capable of understanding and generating sophisticated language based on their trained capacity to capture intricate patterns, semantics and contextual dependencies in textual data. In some scenarios, LLMs may incorporate additional modalities, such as combining images or audio input along with textual input to generate multimodal outputs. Types of LLMs include language generation models, language understanding models, and transformer models.

Transformer models, including transformer-type foundation models and transformer-type LLMs, are a class of deep learning models used in natural language processing (NLP). Transformer models are based on a neural network architecture which uses self-attention mechanisms to process input data and capture contextual relationships between words in a sentence or text passage. Transformer models weigh the importance of different words in a sequence, allowing them to capture long-range dependencies and relationships between words. GPT (Generative Pre-trained Transformer) models, BERT (Bidirectional Encoder Representations from Transformer) models, ERNIE (Enhanced Representation through kNowledge IntEgration) models, T5 (Text-to-Text Transfer Transformer), and XLNet models are types of transformer models which have been pretrained on large amounts of text data using a self-supervised learning technique called masked language modeling. Indeed, large language models, such as ChatGPT and its brethren, have been pretrained on an immense amount of data across virtually every domain of the arts and sciences. Such pretraining allows the models to learn a rich representation of language that can be fine-tuned for specific NLP tasks, such as text generation, language translation, or sentiment analysis.

Advantages of the technology disclosed herein include automated content generation which can be performed on the fly (e.g., in response to a user query) and which can be catalogued and stored for reuse. A benefit of just-in-time content generation is that the recorded content will always be fresh: when the application of interest is updated (e.g., a new version is released), recorded content can be automatically generated for the updated application. Similarly, recorded content can be captured for different versions of the application depending on the version the user is working with and the platform or operating system (e.g., Windows, Macintosh, Linux) hosting the application. Thus, the user need not try to “translate” instructions specific to one platform for use on another. Other benefits include improved user engagement with an application by providing instructional content in multiple modalities. While some users may prefer written instructions, others may find that viewing a simulated user interaction produced by the technology disclosed herein is more effective for understanding how to accomplish a task. Further, because teaching may be accomplished more effectively by providing a visual demonstration of the instructional content, the task will be accomplished more quickly and more efficiently than, say, trial and error.

Technical effects of the technology disclosed herein include the use of generative AI to generate lists of GUI elements for a sequence of steps and source code or scripts for a browser automation tool which enables a number of efficiencies. Automating the process of content generation will be accomplished more quickly than doing so manually which in turn reduces compute costs (e.g., processor usage, time). Technical effects also include simplified software development—the software development is significantly reduced from what would be necessary for deterministic algorithms to accomplish to what can be accomplished via LLM or other generative AI model integrations. Simplified software development also reduces development time.

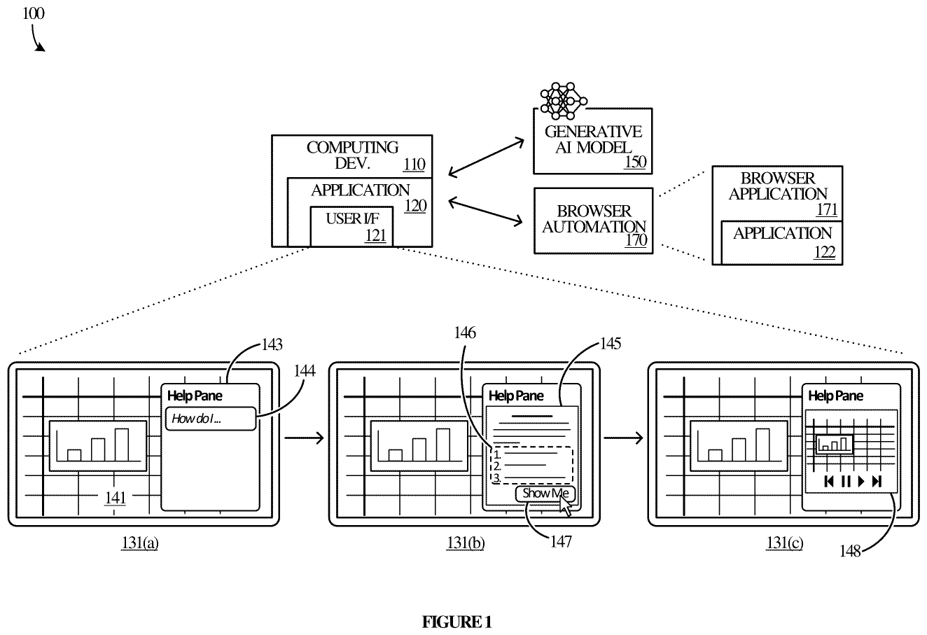

Turning now to the Figures, FIG. 1 illustrates operational environment 100 for a system for automated content generation for instructional information via generative AI in an implementation. Operational environment 100 includes computing device 110 hosting or executing a local runtime environment of application 120 displaying user interface 121. User interface 121 displays user experiences 131(a)-(c) of application 120. Computing device 110 is in communication with generative AI model 150, including sending prompts to generative AI model 150 and receiving output generated by the model in accordance with its training. Computing device 110 also communicates with browser automation tool 170, including sending scripts for execution by browser automation tool 170 and capturing imagery of activity performed by a browser automation tool 170 with respect to an instance of application 120.

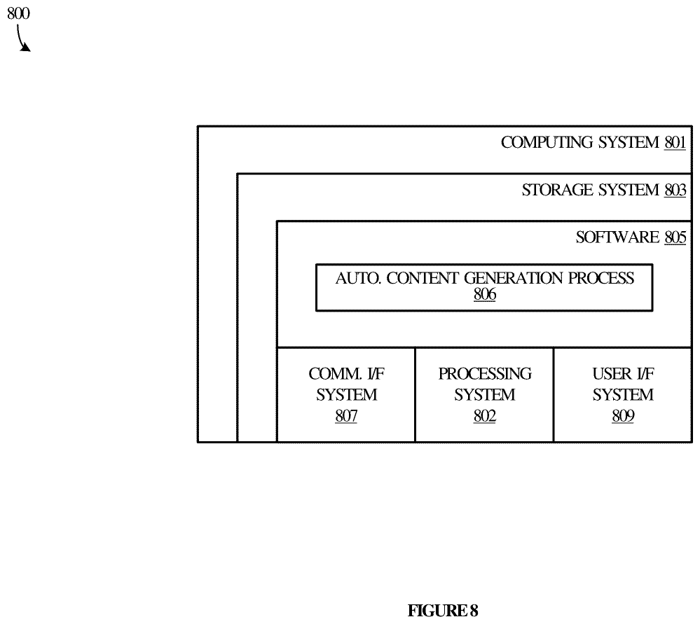

Computing device 110 is representative of a computing device, such as a laptop or desktop computer, or mobile computing device, such as a tablet computer or cellular phone, of which computing system 801 in FIG. 8 is broadly representative. Computing device 110 communicates with generative AI model 150 and/or browser automation tool 170 via one or more internets and intranets, the Internet, wired or wireless networks, local area networks (LANs), wide area networks (WANs), and any other type of network or combination thereof.

Application 120 is representative of a software application, such as a productivity application, which a user interacts with to accomplish various tasks and which may be hosted in a browser window. Application 120 may execute locally on a user computing device, such as computing device 110, or application 120 may execute on one or more servers in communication with computing device 110 over one or more wired or wireless connections, causing user interface 121 to be displayed on computing device 110. In some scenarios, application 120 may execute in a distributed fashion, with a combination of client-side and server-side processes, services, and sub-services. For example, the core logic of application 120 may execute on a remote server system with user interface 121 displayed on a client device. In still other scenarios, computing device 110 is a server computing device, such as an application server, capable of displaying user interface 121, and application 120 executes locally with respect to computing device 110.

Application 120 executing locally with respect to computing device 110 may execute in a stand-alone manner, within the context of another application such as a presentation application or word processing application, or in some other manner entirely. In an implementation, application 120 hosted by a remote application service and running locally with respect to computing device 110 may be a natively installed and executed application, a browser-based application, a mobile application, a streamed application, or any other type of application capable of interfacing with the remote application service and providing local user experiences displayed in user interface 121 on the remote computing device.

Computing device 110 executes application 120 locally which provides a local user experience, as illustrated by user experiences 131(a)-(c) via user interface 121. Application 120 running locally with respect to computing device 110 may be a natively installed and executed application, a browser-based application, a mobile application, a streamed application, or any other type of application capable of interfacing with generative AI model 150 and providing a user experience displayed in user interface 121 on computing device 110. Application 120 may execute in a stand-alone manner, within the context of another application, or in some other manner entirely.

In user interface 121, user experiences 131(a)-(c) are representative of a local user experience hosted by application 120 in an implementation. In user experience 131(a), document 141 is along with help pane 143 which is representative of an application assistant functionality or service by which application 120 can interact with a user to provide assistance in using application 120 among other services. Although document 141 is depicted as a spreadsheet, it may be appreciated that the technology disclosed herein is applicable to applications which host other kinds of content or object containers (e.g., word processing documents, slide presentations, project canvases, and the like) as well as to other types of applications which may be hosted in a browser application with no less of generality. Indeed, the technology disclosed herein may be used to generate instructional content for tasks in browser applications themselves.

Generative AI model 150 is representative of a deep learning model trained for natural language processing tasks or generative pretrained transformer (GPT) computing model or architecture, such as GPT-4. Generative AI model 150 is hosted by one or more computing services which provide services by which application 120 can communicate with generative AI model 150, such as an application programming interface (API). In communicating with application 120, generative AI model 150 may send and receive information (e.g., prompts and replies to prompts) in data objects, such as JavaScript Object Notation (JSON) objects. Generative AI model 150 may be implemented in the context of one or more server computers co-located or distributed across one or more data centers.

Browser automation tool 170 is representative of a service or functionality which automates interaction with browser application 171, including interaction of browser application 171 with application 122, an instance of application 120 hosted by the browser application 171. In other words, browser automation tool 170 causes browser application 171 to act as a robot to interact with application 122 in a prescribed manner according to an automation script. In some implementations, browser automation tool 170 is a Selenium engine which may execute scripts in a number of different programming languages, such as C#, Java, Perl, PHP, Python, and Ruby.

A brief operational scenario of operational environment 100 follows. A user of computing device 110 interacts with application 120 hosting user experiences 131(a)-(c) via user interface 121. As illustrated in user experience 131(a), the user has entered input 144 in help pane 143 including a natural language request information for performing a task in application 120. Upon receiving input 144, application 120 searches existing instructional content to identify an article, instructions, or other type of information relating to the user's query. Upon identifying such content, application 120 causes the content to be surfaced in help pane 143 as illustrated user experience 131(b).

In help pane 143 of user experience 131(b), instructional content 145 includes sequence 146 of steps for performing a task to accomplish the intended outcome of the user's query. Help pane 143 also includes graphical button 147 by which the user can request an illustration of sequence 146, such as a video or series of images demonstrating how sequence 146 is performed.

Continuing with the brief operational scenario of operational environment 100, application 120 produces video 148 which demonstrates sequence 146, i.e., the prescribed interaction as a user can perform sequence 146 in application 120. To produce video 148, application 120 generates a script (not shown) for browser automation tool 170 based on sequence 146. In various implementations, to generate the script, application 120 sends sequence 146 to generative AI model 150 and tasks the model with generating a list of GUI elements of application 120 which a user would use (e.g., click, select) to perform sequence 146. Upon receiving the list of GUI elements, application 120 generates a script to be executed by browser automation tool 170 which will perform the actions described in sequence 146 of steps based on the list of GUI elements. When browser automation tool 170 executes the script, browser automation tool 170 captures video 148 of the interaction between browser application 171 of browser automation tool 170 interacting in the prescribed manner with application 122, an instance of application 120. Subject to post-processing, video 148 is then surfaced in user interface 121, e.g., in help pane 143 as illustrated in user experience 131(c). Thus, when the user plays video 148, the user is able to see a simulated user interaction with application 120 which will accomplish the intended outcome of input 144.

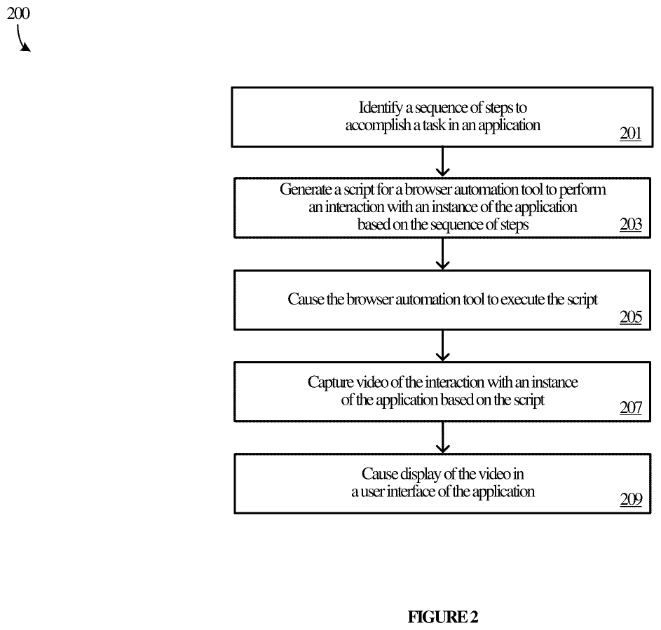

FIG. 2 illustrates a method for a system for automated content generation for instructional information via generative AI in an implementation, herein referred to as process 200. Process 200 may be implemented in program instructions in the context of any of the software applications, modules, components, or other such elements of one or more computing devices. The program instructions direct the computing device(s) to operate as follows, referred to in the singular for the sake of clarity.

In various implementations, a computing device hosts an application (referred to hereinafter as the “target application” for ease of description), and a user interacting with the target application via the application's user interface requests instructions for performing a task in the target application. For example, the user may enter a query (e.g., key in or speak a query which is transcribed by a speech-to-text engine) to a chat-based help pane or application assistant hosted by the target application.

The computing device hosting the target application identifies a sequence of steps to accomplish the task in the application (step 201). In an implementation, the computing device identifies instructional content including a sequence of steps for accomplishing the task. For example, the computing device may perform a keyword search of an existing knowledge base (e.g., help articles, application documentation, user manuals) of the target application to identify one or more relevant help articles, instructions, or other types of instructional content to surface in the user interface. The instructional content may include a sequence of steps the user is to perform in the user interface of the target application.

In some scenarios, to identify the sequence of steps to accomplish the task, the computing device submits a prompt including the user query to a generative AI model, such as an LLM, which tasks the model with generating the instructional content responsive to the query. For example, the prompt may task the model with generating a sequence of steps that the user is to perform to accomplish the task including specific references to GUI elements of the target application. The process of prompting the generative AI model may include Retrieval Augmented Generation (RAG) whereby the computing device includes in the prompt relevant information about the target application and/or its user interface on which the generative AI model is to base its answer. The information provided in the prompt may include documentation which describes the GUI elements of the target application including the actions performed and an organizational structure or hierarchy which describes the relationships between the various elements (e.g., a menu includes five options each of which as a number of settings specific to the respective option).

Next, the computing device generates a script for a browser automation tool to perform an interaction with an instance of the target application based on the sequence of steps (step 203). In an implementation, the computing device generates source code which is executable by a browser automation tool which causes a browser application (“browser”) to perform the sequence of steps in an instance of the target application. In some implementations, to generate the script, the computing device may populate a script template according to the list of GUI elements. The script template may include preparatory steps which direct the browser application to launch an instance of the target application in the browser window, open a document or other object container in the target application, and populate the object container with sample data. The script template may also include instructions for closing the object container and closing the target application once the task is completed. The script template may also identify the particular version or platform of the target application to be used for performing the prescribed interaction.

In an implementation, to generate the script, the computing device may task a generative AI model to generate a list of GUI elements of the target application which are referenced directly or indirectly in the sequence of steps. When the generative AI model returns the list, the computing device may generate the script based on populating a script template according to the listed GUI elements, or the computing device may task the same or other generative AI model with generating the script based on the list of GUI elements. In prompting the generative AI model, the prompt may instruct the model to include preliminary or preparatory steps in the script, such as code lines for launching the target application in the browser window, opening a document or other object container in the target application, and populating the object container with sample data.

The computing device causes the browser automation tool to execute the script (step 205). In an implementation, the computing device opens or executes the browser automation tool and causes the browser automation tool to launch a browser. Executing the script may cause the browser automation tool to launch the target application in a browser window. The script may also cause the browser automation tool to populate a content object (e.g., a document or spreadsheet) of the target application with sample data for the purpose of demonstrating the sequence of steps. The script may then direct the browser to interact with the targeted application to accomplish the task specified in the user query.

When the browser automation tool executes the script, the computing device captures video of the scripted interaction with the instance of the targeted application (step 207). In an implementation, the browser automation tool captures video of the browser window in which the instance of the targeted application is executing. During the scripted interaction, the browser automation tool may cause the GUI elements referenced in the script to be visually highlighted in the browser window. In some cases, the script may direct the browser automation tool to add captions to the video based on the sequence of steps as the steps are performed, although in some cases the computing device may add captions during post-processing. By capturing video as the steps are performed, the end result effects a dynamic simulation of a user interaction with the target application which accomplishes the user's specified task. In some scenarios, the browser automation tool may capture screenshots of the browser window as each step of the sequence is completed in addition to or instead of recording a video of the interaction. When the scripted interaction is completed, the browser automation tool may close the instance of the target application, the browser window, and the browser, then send the captured video and/or screenshots to the computing device for post-processing.

To post-process the video, the computing device may edit the video to remove periods of inactivity to shorten the length of the video. In some instances, the computing device may itself capture screenshots corresponding to the steps in the sequence rather than obtaining the screenshots from the browser automation tool. Other post-processing operations may include adding a title card to the video, formatting and/or compressing the video for display in the user interface, and cataloguing and storing the video for future use. In some scenarios, a localization module of the computing device may detect the user's location and direct a translation module to translate the instructional content, the sequence of steps, and/or other displayed text into a local language.

The computing device causes the captured video to be displayed in the user interface of the target application (step 209). Upon post-processing the video captured by the browser automation tool, the computing device displays the video in the user interface of the target application. For example, the video may be displayed in the chat pane where the user entered his/her query. In other cases, the video may be displayed in a video viewing pane overlaying the target application. The computing device may also display captured screenshots labeled according to the corresponding step in the user interface. Thus, in addition to receiving written instructions about how to accomplish the specified task, the user can also watch the interaction in the video to better understand how functionalities involved or execute the interaction with guidance from the captioned screenshots.

Returning to FIG. 1, operational environment 100 includes a brief example of process 200 as employed by elements of operational environment 100 in an implementation. Computing device 110 executes application 120 including causing local user experiences 131(a)-(c) to be displayed via user interface 121. Application 120 may execute locally with respect to computing device 110, or computing device 110 may host application 120 which executes on one or more server computing devices remote from and in communication with computing device 110, or application 120 may execute in distributed, client-server fashion. User experiences 131(a)-(c) may include a chat interface by which the user can interact with application 120 for accessing instruction content relating to application 120.

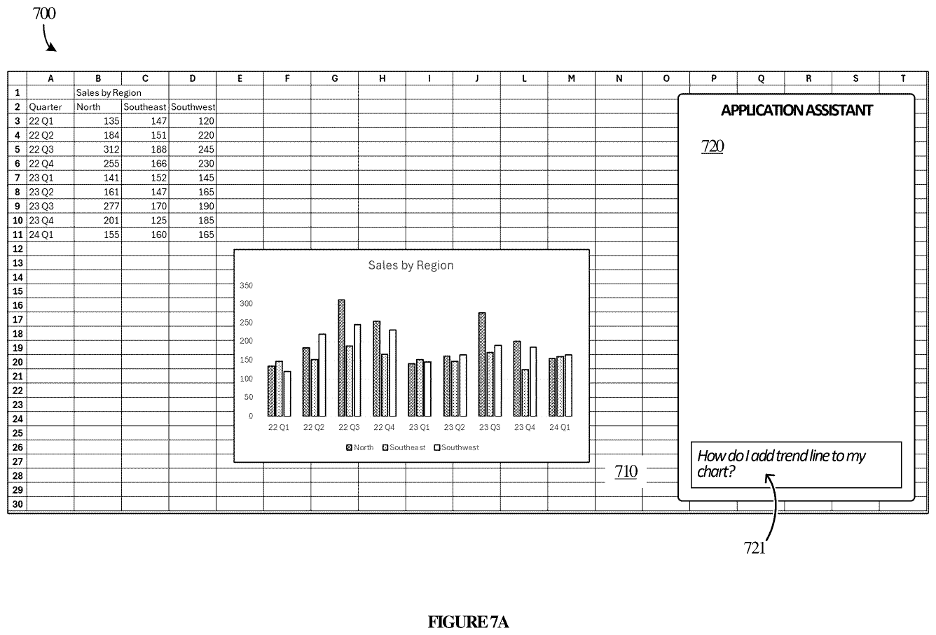

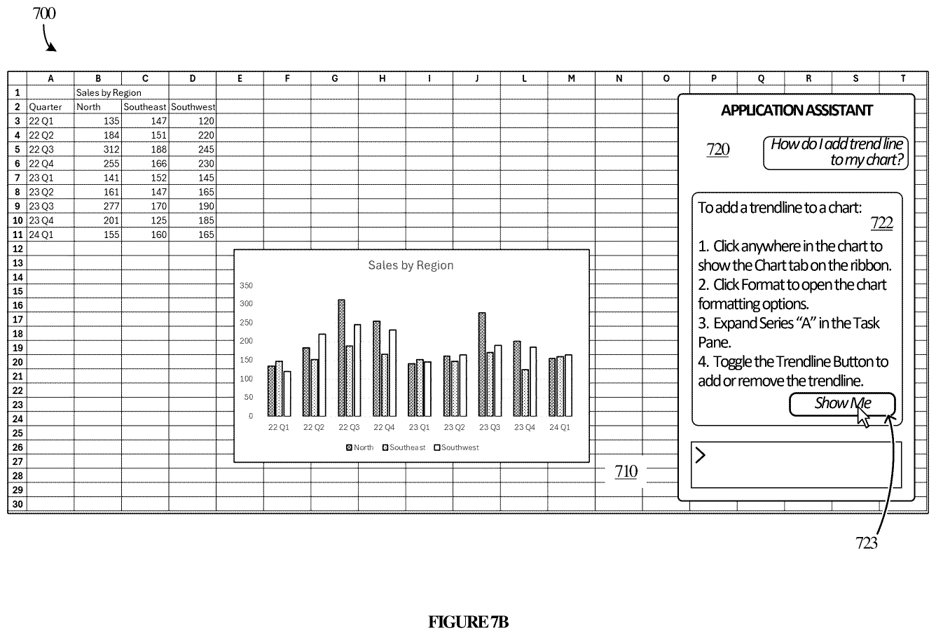

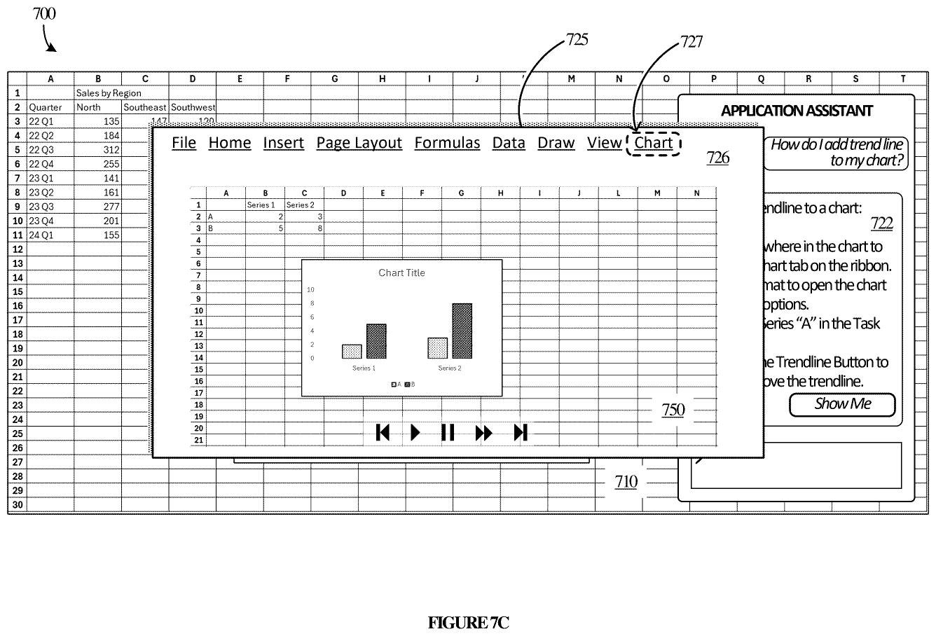

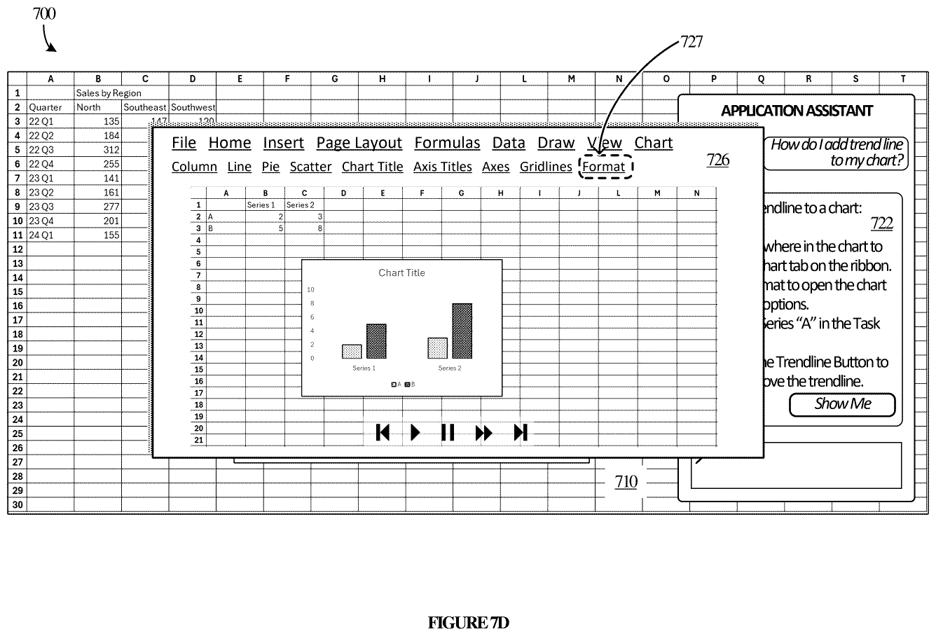

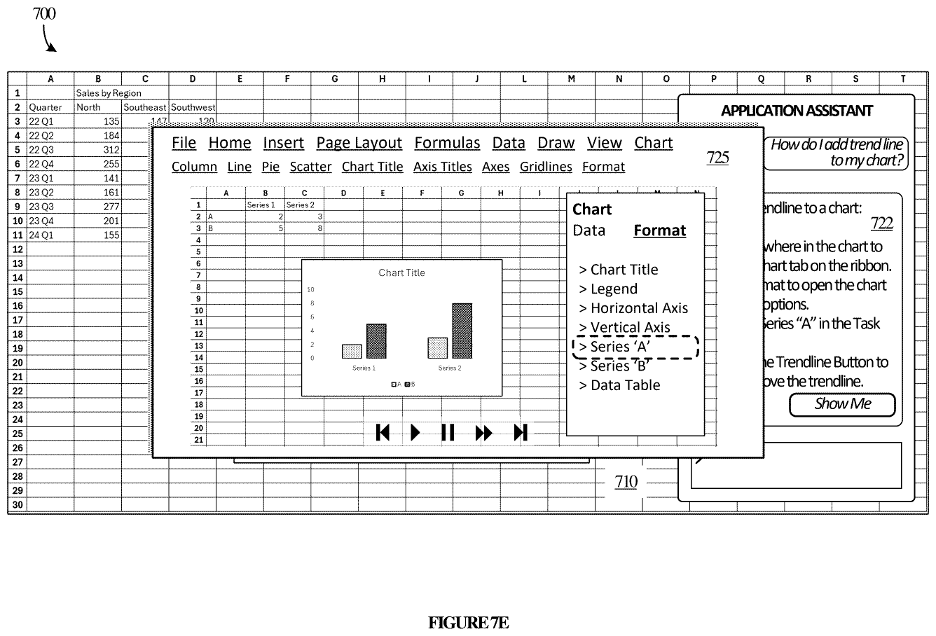

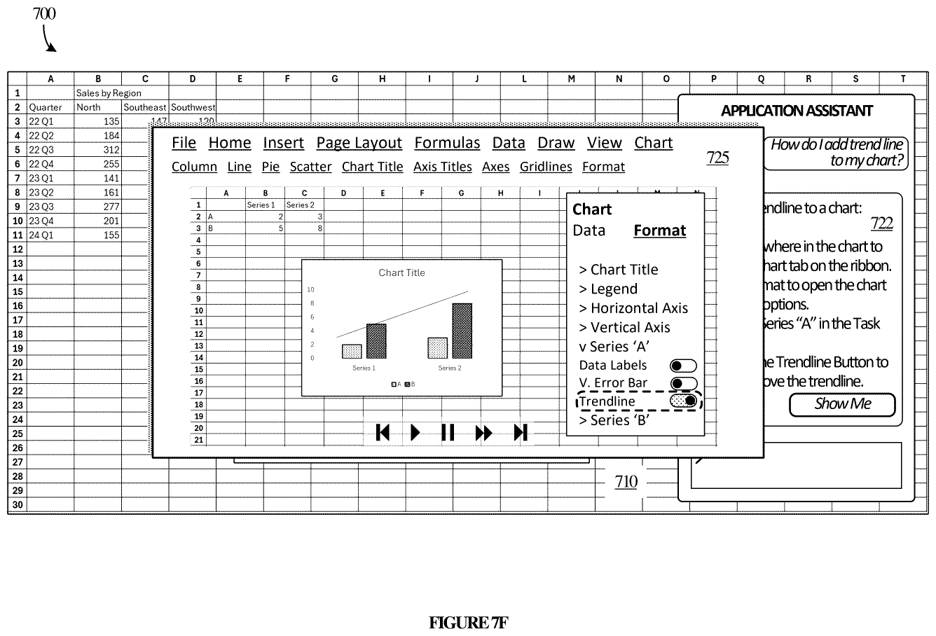

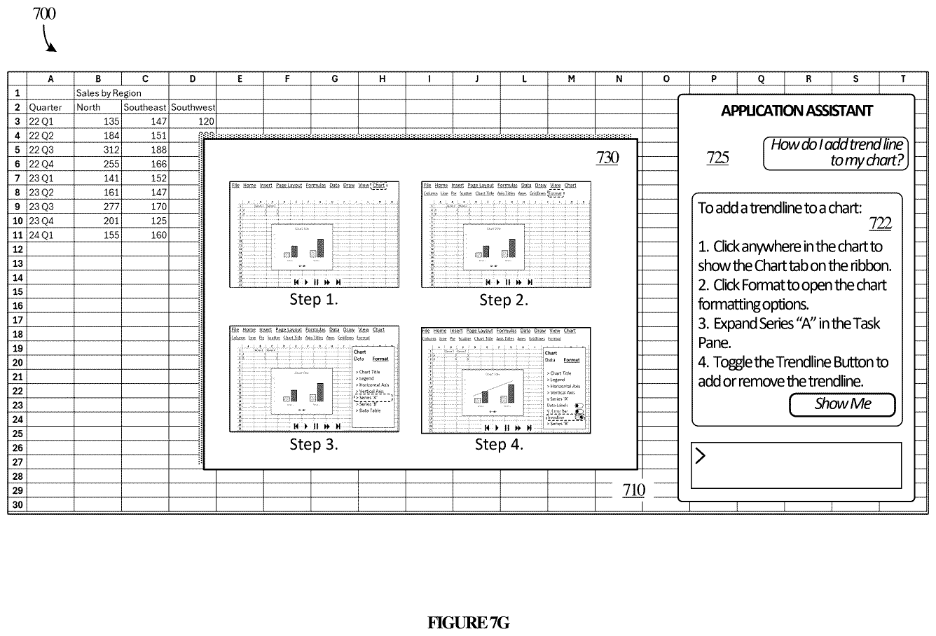

In an operational scenario, application 120 hosted by computing device 110 receives user input 144 including a request for information for accomplishing a task in application 120. For example (and as is demonstrated in FIGS. 7A-7F discussed infra), the user may be working with a data chart in a spreadsheet application and may request instructions for adding a trendline to the chart. In other exemplary uses, the user may request instructions for formatting the page numbering of a document in a word processing application, for animating a graphical element of a slide presentation, or for sharing a project canvas with another user. In some cases, the user may be using a browser application and may request instructions for completing a task in the browser, such as deleting a bookmarked website from a bookmarks menu.

Computing device 110 identifies a sequence of steps to accomplish the requested task in application 120. In some cases, computing device 110 searches a knowledge base associated with application 120 for instructional content (e.g., help article) which explains how to accomplish the requested task. In some implementations, computing device 110 may prompt an LLM, such as generative AI model 150, to generate instructional content for accomplishing the task in application 120. In either case, having identified instructional content 145 relating to user input 144, computing device 110 displays instructional content 145 including sequence 146 of steps which the user is to perform to accomplish the task in user interface 121.

With instructional content 145 displayed in user interface 121, the user requests an illustration or demonstration of sequence 146 via graphical button 147. In response to the request, computing device 110 generates a script for browser automation tool 170 which directs browser application 171 to perform a prescribed interaction with application 122, an instance of application 120 hosted by browser application 171, according to sequence 146. To generate the script, computing device 110 obtains a list of GUI elements based on sequence 146, such as GUI elements directly or indirectly referenced in sequence 146. To obtain the list of GUI elements, computing device 110 may generate a prompt for generative AI model 150 including sequence 146 and instructs generative AI model 150 to generate the list of GUI elements. In some cases, the prompt may include documentation relating to GUI elements and functionality of application 120, and generative AI model 150 may be instructed to generate the list based on the provided documentation.

Having obtained a list of GUI elements, to generate the script, computing device 110 may execute a scripting functionality which populates a script template according to the list of GUI elements. The script template may include boilerplate code including preparatory steps performed before interaction with the GUI elements (e.g., surfacing a document and populating it with sample data) and post-interaction steps such as ending the recording, closing the target application and the browser, and so on. In some scenarios, computing device 110 may prompt a generative AI model, such as generative AI model 150 or a different model, to generate the script based on the list of GUI elements. For example, computing device 110 may prompt an LLM which has been fine-tuned to generate scripts based on lists of GUI elements of a given application. In some cases, the script generated by the generative AI model may be used to populate a script template which includes boilerplate code as described above.

Having obtained a script for performing the prescribed interaction, computing device 110 causes browser automation tool 170 to execute the script. As browser automation tool 170 executes the script, browser application 171 opens a window and launches application 122 in the window. In the exemplary scenario illustrated in operational environment 100, the task is to be performed in document 141, so the script causes application 122 to open a sample document of the same type as document 141 and populate the document with sample content to which the task relates (e.g., a data chart).

The browser automation tool directs browser application 171 to perform the prescribed actions with respect to various GUI elements of application 122 in accordance with sequence 146. As browser application 171 performs the actions, browser automation tool 170 captures video 148 of the interaction in the browser window. In some scenarios, however, the video recording is captured not by browser automation tool 170 but instead by a recording functionality of computing device 110.

With video 148 of the prescribed interaction captured, video 148 may be processed for display in user interface 121 of application 120. For example, extraneous footage may be edited out of video 148, captions may be added, a title card may be added, video 148 may be reformatted or compressed, and so on. When post-processing of video 148 is complete, computing device 110 causes video 148 to be displayed in user interface 121. Thus, the user is able to view a demonstration of the prescribed interaction to accomplish the desired task.

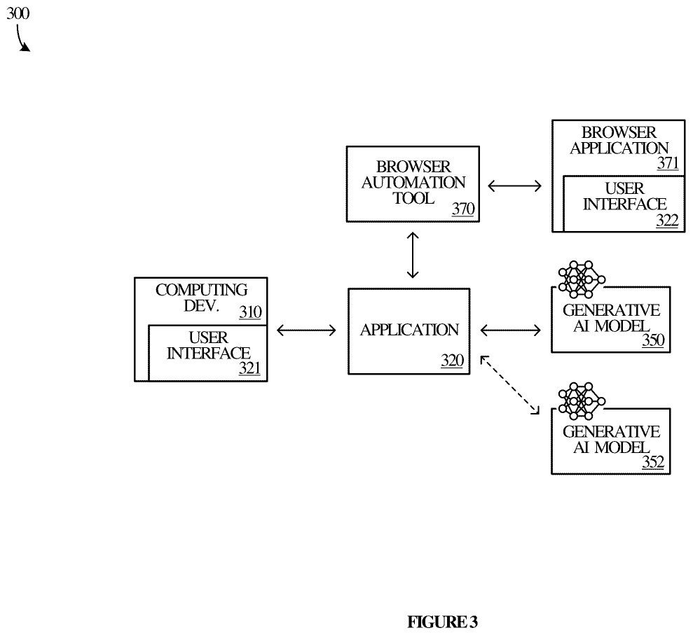

Turning now to FIG. 3, FIG. 3 illustrates operational environment 300 for automated content generation for instructional information via generative AI integration in an implementation. Operational environment 300 includes computing device 310, application 320, generative AI models 350 and 352, and browser automation tool 370. Computing device 310 displays user interface 321 of application 320. Browser automation tool 370 hosts browser application 330 which in turn hosts user interface 322 of application 320.

Computing device 310 is representative of a computing device, such as a laptop or desktop computer, or mobile computing device, such as a tablet computer or cellular phone, of which computing system 801 of FIG. 8 is broadly representative. Computing device 310 communicates with application 320 via one or more internets and intranets, the Internet, wired or wireless networks, local area networks (LANs), wide area networks (WANs), and any other type of network or combination thereof.

Application 320 is representative of a software application which may execute locally on a user computing device, such as computing device 310, or application 320 may be hosted on one or more servers in communication with computing device 310 over one or more wired or wireless connections. Application 320 hosts user interface 321 on computing device 310 and user interface 322 in browser application 371. For example, a local instance of application 320 may host user interface 321 on computing device 310, and a second instance of application 320 may host user interface 322 in browser application 371. Examples of such servers include web servers, application servers, virtual or physical (bare metal) servers, or any combination or variation thereof, of which computing system 801 in FIG. 8 is broadly representative. In some scenarios, application 320 may execute in a distributed fashion, with a combination of client-side and server-side processes, services, and sub-services. For example, the core logic of application 320 may execute on a remote server system with user interfaces displayed on remote (e.g., client) computing devices.

Application 320 executing locally with respect to computing device 110 may execute in a stand-alone manner, within the context of another application such as a browser application, or in some other manner entirely. Application 320 may be a natively installed and executed application, a browser-based application, a mobile application, a streamed application, or any other type of application capable of interfacing with a remote application service and providing local user experiences displayed in user interface 321 on the remote computing device.

Generative AI models 350 and 352 are representative of deep learning models capable of performing natural language processing tasks. In some cases, generative AI models 350 and 352 may be fine-tuned versions of general-purpose AI models such as GPT 3.5 or GPT 4 which are trained to perform specific tasks. Generative AI models 350 and 352, of which generative AI model 150 of FIG. 1 is broadly representative, may be implemented in the context of one or more server computers co-located or distributed across one or more data centers which provide services by which application 320 can communicate with the models, such as an API.

Browser automation tool 370 is representative of a computing service or functionality which automates the actions of browser application 371, including interaction of browser application 371 with an instance of application 320. Browser automation tool 370 directs browser application 371 to interact with application 320 in a prescribed manner according to an automation script. In operation, browser automation tool 370 records the interaction or activity of application 320 as a video or in screenshots of the browser window hosting user interface 322 of application 320. In some implementations, browser automation tool 170 is a Selenium engine which executes scripts in a programming language such as C#, Java, Perl, PHP, Python, Ruby, or other languages.

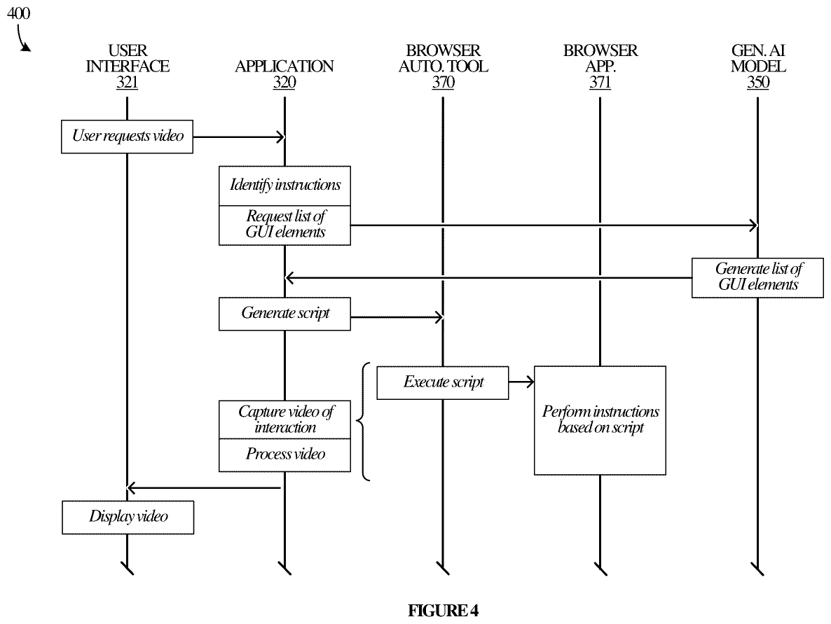

FIG. 4 illustrates workflow 400 for automated content generation of instructional information via generative AI integration in an implementation and in reference to elements of operational environment 300. In workflow 400, a user submits a request in user interface 321 for a video demonstrating the steps to be performed to accomplish a desired task. Application 320 receives the request and identifies instructions (e.g., a sequence of steps for the user to perform in user interface 321) to accomplish the task. For example, application 320 may perform a keyword search of a knowledge base associated with application 320 for instructions for accomplishing the task, or application 320 may prompt a generative AI model, such as generative AI model 350 or another model, to generate instructions for accomplishing the task based on the user request. For example, the prompt for the generative AI model may include documentation relating to functionalities and GUI elements of application 320, and the model may be tasked with generating the instructions based on the supplied information.

Next, application 320 prompts generative AI model 350 to generate a list of GUI elements of user interface 321 which a user would interact with in performing the instructions. Here, again, generative AI model may be a fine-tuned model trained for generating lists of GUI elements of application 320, or the prompt to generative AI model 350 may include documentation relating to functionalities and GUI elements of application 320 on which the model is to base its answer.

Application 320 receives the list of GUI elements from generative AI model 350, then generates an automation script which, when executed by browser automation tool 370, causes browser application 371 to perform the prescribed interaction. Browser automation tool 370 receives the automation script and executes the script, causing the browser application 371 to be launched and an instance of application 320 to be opened in a browser window. Browser application 371 interacts with application 320 in user interface 322 according to the script.

As the script is executed, browser automation tool 370 captures video of the interaction. When execution of the script is completed, application 320 processes the video for display in user interface 321, such as formatting the video for display in user interface 321 and storing the video for future use. Application 320 causes display of the video in user interface 321. In various implementations, application 320 may also present the user with a document or webpage including screenshots of the interaction (e.g., screencaptures from the video) corresponding to the various steps to be performed for accomplishing the task.

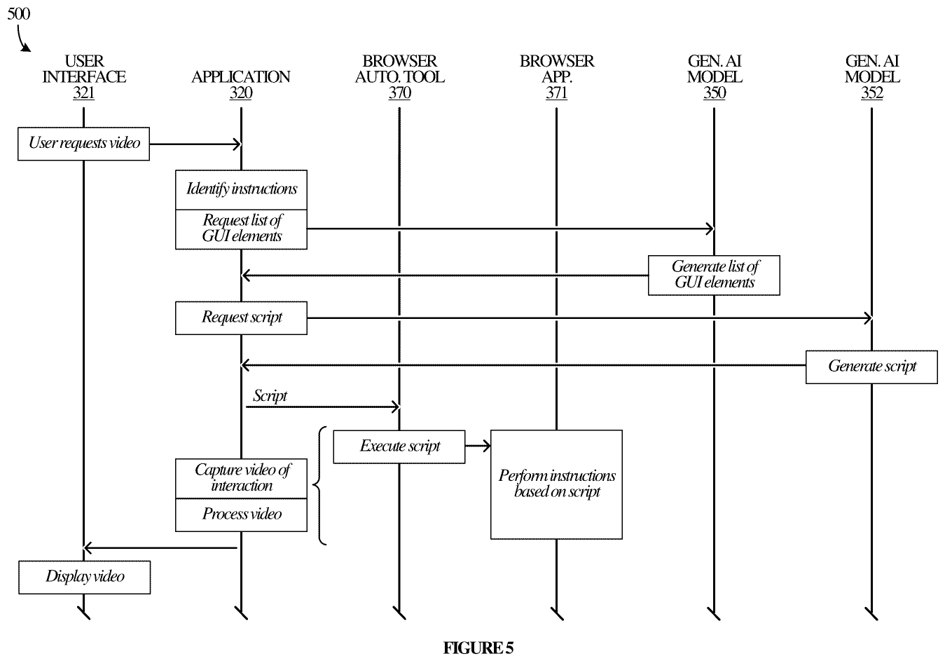

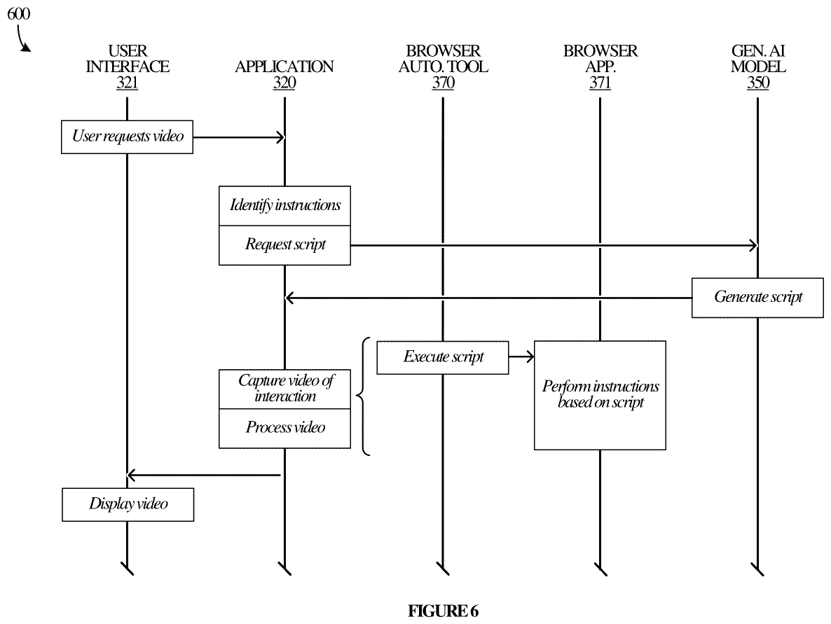

FIGS. 5 and 6 illustrate workflows 500 and 600 respectively for automated content generation of instructional information via generative AI integration in an implementation and in reference to elements of operational environment 300.

Workflow 500 proceeds similarly to workflow 400, however, to generate the automation script, application 320 prompts generative AI model 352 to generate the script based on the list of GUI elements. For example, generative AI model 352 may be a fine-tuned model trained to generate scripts for browser automation tool 370 based on lists of GUI elements corresponding to instructional content. The training data for fine-tuning generative AI model 352 may include documentation for scripting in browser automation tool 370. Alternatively, generative AI model 352 may be a general-purpose model, and the prompt may be augmented with documentation for scripting for browser automation tool 370 which the model is instructed to use in generating its output.

Workflow 600 proceeds similarly to workflow 400, however, in workflow 600, application 320 prompts generative AI model 350 to generate the automation script based on the identified instructions rather than on a list of GUI elements. For example, application 320 may generate a prompt including the identified instructions (e.g., a sequence of steps) along with other information relating to application 320 and the GUI elements of application 320. In some cases, generative AI model 350 may be a fine-tuned model trained to generate automation script based on information from a knowledge base for application 320. The knowledge base may include documentation for application 320 as well as textual content relating to performing tasks in application 320 found from other sources such as user manuals, technical documentation, application source code, websites (e.g., Frequently Asked Questions (FAQs) webpages, user or community forums), and so on. In some cases, the prompt for generating the automation script may be augmented with information from the knowledge base which the model is instructed to use in generating its output.

FIGS. 7A-7G illustrate user experience 700 for automated content generation of instructional information via generative AI integration at various stages of operation in an implementation. In user experience 700 of FIG. 7A, a user is working with a data table and data chart in user interface 710 of a software application (e.g., a spreadsheet application), of which application 120 of FIG. 1 is broadly representative. The user enters user input 721, a natural language query relating to the data chart (“How do I add trend line to my chart?”), in application assistant pane 720. In user experience 700 in FIG. 7B, the application surfaces instructions 722 responsive to user input 721 including a sequence of steps the user is to perform to accomplish the user's desired task. As illustrated, instructions 722 include four enumerated steps that the user is to perform to accomplish the desired task. Also presented with instructions 722 is button 723 by which the user requests a visual demonstration (e.g., a video) of the written instructions.

In FIG. 7C, the application surfaces viewing pane 725 including video 726 which was generated based on instructions 722, particularly the sequence of steps of instructions 722, according to an implementation of the technology disclosed herein. To generate video 726, the application generates an automation script for a browser automation tool, of which browser automation tool 170 is representative. When the browser automation tool executes the script, the script directs the automation tool to open user interface 750 of an instance of the application in a browser window. The automation script includes contextual information for user input 721 such as the type of document or object container to be opened in the browser window and a description of objects to be created in the object container (e.g., sample data, sample chart). As illustrated in FIG. 7C, based on the script, the browser has populated the sample spreadsheet in user interface 750 with sample data and a sample chart for the demonstration.

As user experience 700 proceeds through FIGS. 7C-7F, video 726 demonstrates the four steps listed in instructions 722 in application assistant pane 720. In some implementations, the browser automation tool adds captions to video 726 based on the steps of instructions 722 (e.g., based on enumerated steps of instructions 722). The browser automation tool may visually highlight GUI elements of user interface 750 that are pertinent to instructions 722, such as GUI elements 727 of FIGS. 7C and 7D. Video 726 may be stored by the application for future use, e.g., when the application receives another request for instructions for the desired task.

FIG. 7G illustrates user experience 700 including view pane 730 displaying screenshots of the GUI interaction corresponding to the four steps of instructions 722. In various implementations, the screenshots are captured from video 726 or as the script executed.

FIG. 8 illustrates computing device 801 that is representative of any system or collection of systems in which the various processes, programs, services, and scenarios disclosed herein may be implemented. Examples of computing device 801 include, but are not limited to, desktop and laptop computers, tablet computers, mobile computers, and wearable devices. Examples may also include server computers, web servers, cloud computing platforms, and data center equipment, as well as any other type of physical or virtual server machine, container, and any variation or combination thereof.

Computing device 801 may be implemented as a single apparatus, system, or device or may be implemented in a distributed manner as multiple apparatuses, systems, or devices. Computing device 801 includes, but is not limited to, processing system 802, storage system 803, software 805, communication interface system 807, and user interface system 809 (optional). Processing system 802 is operatively coupled with storage system 803, communication interface system 807, and user interface system 809.

Processing system 802 loads and executes software 805 from storage system 803. Software 805 includes and implements automated content generation process 806, which is (are) representative of the automated content generation processes discussed with respect to the preceding Figures, such as process 200 and workflows 400, 500, and 600. When executed by processing system 802, software 805 directs processing system 802 to operate as described herein for at least the various processes, operational scenarios, and sequences discussed in the foregoing implementations. Computing device 801 may optionally include additional devices, features, or functionality not discussed for purposes of brevity.

Referring still to FIG. 8, processing system 802 may comprise a micro-processor and other circuitry that retrieves and executes software 805 from storage system 803. Processing system 802 may be implemented within a single processing device but may also be distributed across multiple processing devices or sub-systems that cooperate in executing program instructions. Examples of processing system 802 include general purpose central processing units, graphical processing units, application specific processors, and logic devices, as well as any other type of processing device, combinations, or variations thereof.

Storage system 803 may comprise any computer readable storage media readable by processing system 802 and capable of storing software 805. Storage system 803 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 803 may also include computer readable communication media over which at least some of software 805 may be communicated internally or externally. Storage system 803 may be implemented as a single storage device but may also be implemented across multiple storage devices or sub-systems co-located or distributed relative to each other. Storage system 803 may comprise additional elements, such as a controller, capable of communicating with processing system 802 or possibly other systems.

Software 805 (including automated content generation process 806) may be implemented in program instructions and among other functions may, when executed by processing system 802, direct processing system 802 to operate as described with respect to the various operational scenarios, sequences, and processes illustrated herein. For example, software 805 may include program instructions for implementing an automated content generation process as described herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 805 may include additional processes, programs, or components, such as operating system software, virtualization software, or other application software. Software 805 may also comprise firmware or some other form of machine-readable processing instructions executable by processing system 802.

In general, software 805 may, when loaded into processing system 802 and executed, transform a suitable apparatus, system, or device (of which computing device 801 is representative) overall from a general-purpose computing system into a special-purpose computing system customized to support automated generation of content in an optimized manner. Indeed, encoding software 805 on storage system 803 may transform the physical structure of storage system 803. The specific transformation of the physical structure may depend on various factors in different implementations of this description. Examples of such factors may include, but are not limited to, the technology used to implement the storage media of storage system 803 and whether the computer-storage media are characterized as primary or secondary storage, as well as other factors.

For example, if the computer readable storage media are implemented as semiconductor-based memory, software 805 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 807 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing device 801 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Indeed, the included descriptions and figures depict specific embodiments to teach those skilled in the art how to make and use the best mode. For the purpose of teaching inventive principles, some conventional aspects have been simplified or omitted. Those skilled in the art will appreciate variations from these embodiments that fall within the scope of the disclosure. Those skilled in the art will also appreciate that the features described above may be combined in various ways to form multiple embodiments. As a result, the invention is not limited to the specific embodiments described above, but only by the claims and their equivalents.

What is claimed is:

1. A computing apparatus, comprising:
one or more computer readable storage media;
one or more processors operatively coupled with the one or more computer readable storage media; and
program instructions stored on the one or more computer readable storage media that, when executed by the one or more processors, direct the computing apparatus to at least:
identify a sequence of steps to accomplish a task in an application;
generate a script for a browser automation tool to perform an interaction with an instance of the application based on the sequence of steps;
cause the browser automation tool to execute the script;
capture a video of the interaction with an instance of the application based on the script; and
cause display of the video in a user interface of the application.

2. The computing apparatus of claim 1, wherein the program instructions further direct the computing apparatus to prompt a generative artificial intelligence (AI) model to generate a list of graphical user interface (GUI) elements based on the sequence of steps.

3. The computing apparatus of claim 2, wherein to generate the script for the browser automation tool to perform the interaction with the instance of the application, the program instructions direct the computing apparatus to generate the script for the browser automation tool to interact with the instance of the application based on the list of GUI elements.

4. The computing apparatus of claim 1, wherein to capture the video of the interaction with the instance of the application, the program instructions direct the computing apparatus to capture the video of the interaction with the instance of the application in a window of a browser application.

5. The computing apparatus of claim 1, wherein to generate the script for the browser automation tool to perform the interaction with the instance of the application, the program instructions direct the computing apparatus to prompt a large language model to generate the script for the browser automation tool to perform the interaction with the instance of the application based on the sequence of steps.

6. The computing apparatus of claim 1, wherein to identify the sequence of steps to accomplish the task in the application, the program instructions direct the computing apparatus to prompt a large language model to generate the sequence of steps based on a knowledge base of the application.

7. The computing apparatus of claim 1, further comprising causing display of screenshots from the video in the user interface of the application.

8. The computing apparatus of claim 1, wherein to identify the sequence of steps to accomplish the task in the application, the program instructions further direct the computing apparatus to receive user input comprising a request for information to accomplish the task in the application.

9. A method of operating a computing device, comprising:
identifying a sequence of steps to accomplish a task in an application;
generating a script for a browser automation tool to perform an interaction with an instance of the application based on the sequence of steps;
causing the browser automation tool to execute the script;
capturing a video of the interaction with an instance of the application based on the script; and
causing display of the video in a user interface of the application.

10. The method of claim 9, further comprising prompting a generative artificial intelligence (AI) model to generate a list of graphical user interface (GUI) elements based on the sequence of steps.

11. The method of claim 10, wherein generating the script for the browser automation tool to perform the interaction with the instance of the application comprises generating the script for the browser automation tool to interact with the instance of the application based on the list of GUI elements.

12. The method of claim 9, wherein capturing the video of the interaction with the instance of the application comprises capturing the video of the interaction with the instance of the application in a window of a browser application.

13. The method of claim 9, wherein generating the script for the browser automation tool to perform the interaction with the instance of the application comprises prompting a large language model to generate the script for the browser automation tool to perform the interaction with the instance of the application based on the sequence of steps.

14. The method of claim 9, wherein identifying the sequence of steps to accomplish the task in the application comprises prompting a large language model to generate the sequence of steps based on a knowledge base of the application.

15. One or more computer readable storage media having program instructions stored thereon that, when executed by one or more processors, direct a computing apparatus to at least:
identify a sequence of steps to accomplish a task in an application;
generate a script for a browser automation tool to perform an interaction with an instance of the application based on the sequence of steps;
cause the browser automation tool to execute the script;
capture a video of the interaction with an instance of the application based on the script; and
cause display of the video in a user interface of the application.

16. The one or more computer readable storage media of claim 15, wherein the program instructions further direct the computing apparatus to prompt a generative artificial intelligence (AI) model to generate a list of graphical user interface (GUI) elements based on the sequence of steps.

17. The one or more computer readable storage media of claim 16, wherein to generate the script for the browser automation tool to perform the interaction with the instance of the application, the program instructions direct the computing apparatus to generate the script for the browser automation tool to interact with the instance of the application based on the list of GUI elements.

18. The one or more computer readable storage media of claim 15, wherein to capture the video of the interaction with the instance of the application, the program instructions direct the computing apparatus to capture the video of the interaction with the instance of the application in a window of a browser application.

19. The one or more computer readable storage media of claim 15, wherein to generate the script for the browser automation tool to perform the interaction with the instance of the application, the program instructions direct the computing apparatus to prompt a large language model to generate the script for the browser automation tool to perform the interaction with the instance of the application based on the sequence of steps.

20. The one or more computer readable storage media of claim 15, wherein to identify the sequence of steps to accomplish the task in the application, the program instructions direct the computing apparatus to prompt a large language model to generate the sequence of steps based on a knowledge base of the application.
